(19) United States
(12) Patent Application Publication
(10) Pub. No.: US 2009/0047919 A1
(43) Pub. Date: Feb. 19, 2009

(54) RADIO WITH AUTOMATIC TUNING TO MODULATED AUDIO DEVICE

(76) Inventors: J. William Whikehart, Milford, MI (US); Shaun Kalinowski, Van Buren Township, MI (US)

Correspondence Address: VISTEON/BRINKS HOFER GILSON & LIONE, 524 South Main Street, Suite 200, Ann Arbor, MI, 48104, US

(21) Appl. No.: 11/838,594

(22) Filed: Aug. 14, 2007

(51) Int. Cl. H04B 1/18

(52) U.S. Cl. 455/164.2

(57) ABSTRACT

A system and method for automatically tuning an entertainment system to interface with a modulated audio device includes a processor in communication with a tuner, an audio output device and a memory unit containing processor executable instructions. The processor executable instructions of the memory unit configure the processor to tune the tuner to a predetermined frequency, determine if a signal is present at the predetermined frequency and output an audio signal based on the predetermined frequency to the audio output device if a signal is present at the predetermined frequency.

### BACKGROUND OF THE INVENTION

1. Field of the Invention

The present invention relates to audio entertainment systems and more specifically to audio entertainment systems for automobiles.

2. Description of the Known Technology

Portable audio devices, such as audio devices that utilize solid state memory or a hard disk for storage, such as the iPod from Apple, Inc. of Cupertino, Calif., generally provide audio to the user via a set of earphones. If the user wishes to use the portable audio device while operating an automobile, the user must either use the provided earphones or connect the portable audio device to the automobile's entertainment system.

The first solution of simply using the provided earphones poses several problems, including not allowing others within the cabin of the automobile to listen to the portable audio device. Other solutions involve providing audio signals from the portable audio device to the entertainment system of the automobile, thereby utilizing the speakers already found within the automobile. This is generally accomplished by interfacing the output jack of the portable audio device to an input of the entertainment system. The input of the entertainment system may be a cassette deck, or an auxiliary input, such as a jack. However, there are drawbacks to this solution as well. Using the cassette deck of the entertainment system via an adaptor has become problematic because most automobile manufacturers are phasing out cassette decks. As to interfacing with the entertainment system via an auxiliary port, many automobile manufacturers have yet to provide auxiliary inputs as standard equipment.

Another solution for interfacing with the entertainment system of the automobile involves modulating audio signals from the portable audio device. Generally, this is accomplished by attaching a modulator to the output jack of the portable audio device, which then modulates the audio signals such that the signals can be received by the FM tuner found in the entertainment system of the automobile. Unlike a cassette deck or an auxiliary input, virtually all automobiles have entertainment systems capable of receiving FM signals, thereby allowing these automobiles to interface with the portable audio device via such a device.

However, several additional steps are required when utilizing a modulator. The user must first select a radio frequency in which the modulator will transmit the audio signals from the portable audio device. Thereafter, the user must then tune the entertainment system of the automobile to correspond with the previously selected frequency.

### BRIEF SUMMARY OF THE INVENTION

In overcoming the drawbacks and limitations of the prior art, an improved entertainment system capable of interfacing with a modulated audio device is described. The entertainment system includes a tuner in communication with an antenna, a processor in communication with the tuner and an audio output device in communication with the processor. The processor is configured to instruct the tuner to tune into one or more radio frequencies, while the audio output device is configured to output an audio signal based on the one or more radio frequencies received by the tuner.

A memory unit containing processor executable instructions is in communication with the processor. The processor executable instructions contained within the memory unit configure the processor to tune the tuner to a predetermined frequency, determine if a signal is present at the predetermined frequency and output an audio signal based on the predetermined frequency to an audio output device if a signal is present at the predetermined frequency.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a portion of an occupant compartment of an automotive vehicle containing an entertainment system embodying the principles of the present invention;

FIG. 2 is a block diagram of the entertainment system of FIG. 1; and

FIG. 3 is a block diagram of a method embodying the principles of the present invention for automatically tuning the entertainment system to interface with a modulated audio device.

### DETAILED DESCRIPTION OF THE INVENTION

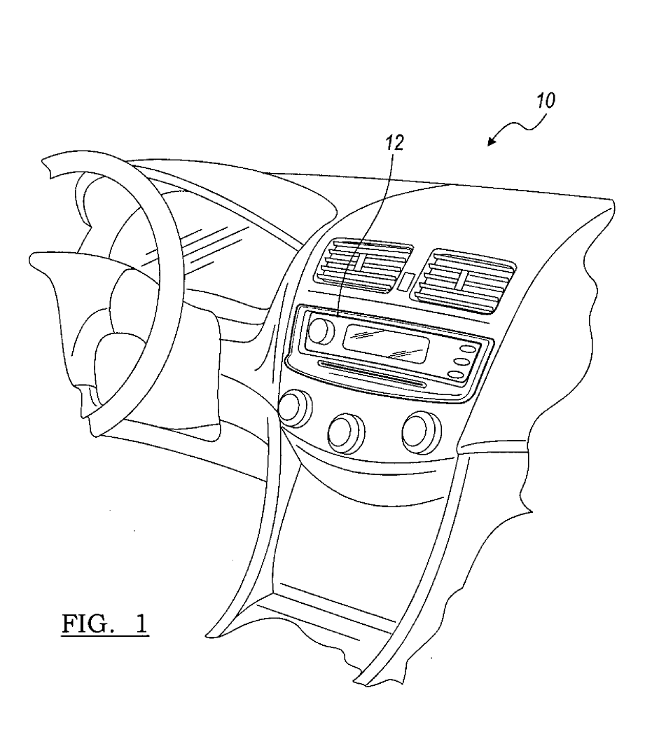

Referring to FIG. 1, an occupant compartment 10 of an automobile is shown. Located within the occupant compartment 10 is an entertainment system 12 capable of automatically tuning itself to interface with a modulated audio device. It should be understood that although the entertainment system 12 is shown installed in an occupant compartment 10 of an automobile, the entertainment system 12 could be utilized in a variety of different environments, such as stand alone audio system commonly found in the home.

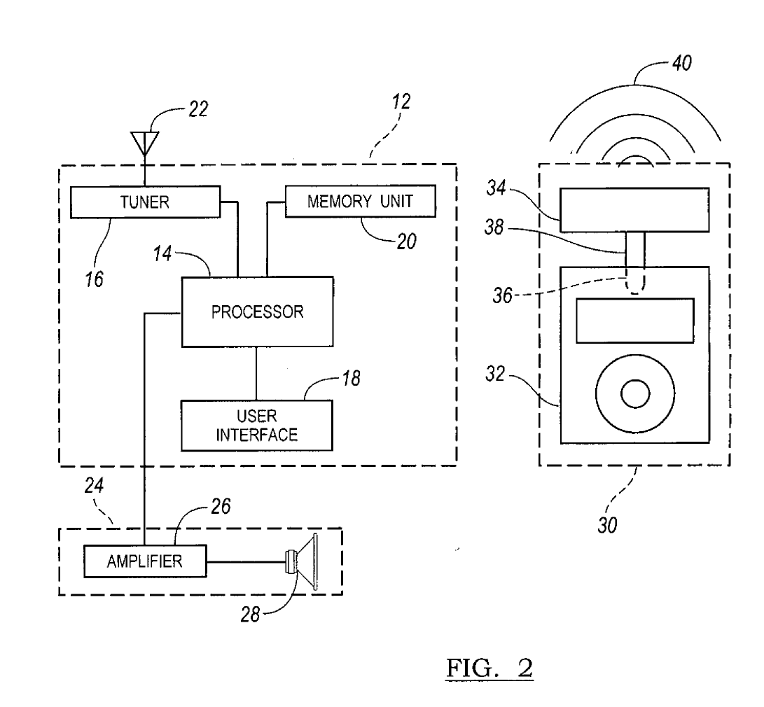

Referring to FIG. 2, a block diagram of the entertainment system 12 is shown. The entertainment system 12 includes a processor 14 in communication with a tuner 16, a user interface 18 and a memory unit 20. The processor 14 is configured to instruct the tuner 16 to tune into one or more radio frequencies by using an antenna 22. Generally, the one or more radio frequencies are the AM or FM bands. The user interface 18 allows an occupant located within the occupant compartment 10 to control and direct with the entertainment system 12. For example, the occupant via the user interface 18, will be able to instruct the processor 14 to configure the tuner to tune into a specific radio frequency.

An audio output device 24 is in communication with the processor 14 of the entertainment system 12. The audio output device 24 includes an amplifier 26 and at least one speaker 28. The audio output device 24 is configured to output an audio signal based on one or more of the frequencies received by the tuner 16. The amplifier 26 receives the appropriate signal from the tuner 16 via the processor 14 and amplifies the signal such that the speaker 28 can audibly broadcast the signal so that the occupant located within the occupant compartment 10 can listen.

A modulated audio device 30 includes a portable audio device 32 and a modulator 34 in communication with the portable audio device 32. The portable audio device 32 outputs an audio device signal to an output jack 36. An input jack 38 of the modulator 34 receives the audio device signal from the output jack 36, in which the modulator 34 outputs a radio wave 40 at a predetermined frequency. The predetermined frequency of the modulator 34 can be a fixed frequency or may be a user selectable frequency. Generally, the predetermined frequency is transmitted on the FM band and is therefore capable of being received by the antenna 22 of the entertainment system 12.

The memory unit 20 contains a set of processor executable instructions to configure the processor 14. As later described, the processor executable instructions configure the processor 14 to tune the tuner 16 to a predetermined frequency, determine if a signal is present at the predetermined frequency, and output audio signal based on the predetermined frequency to the audio output device 24 if a signal is present at the predetermined frequency.

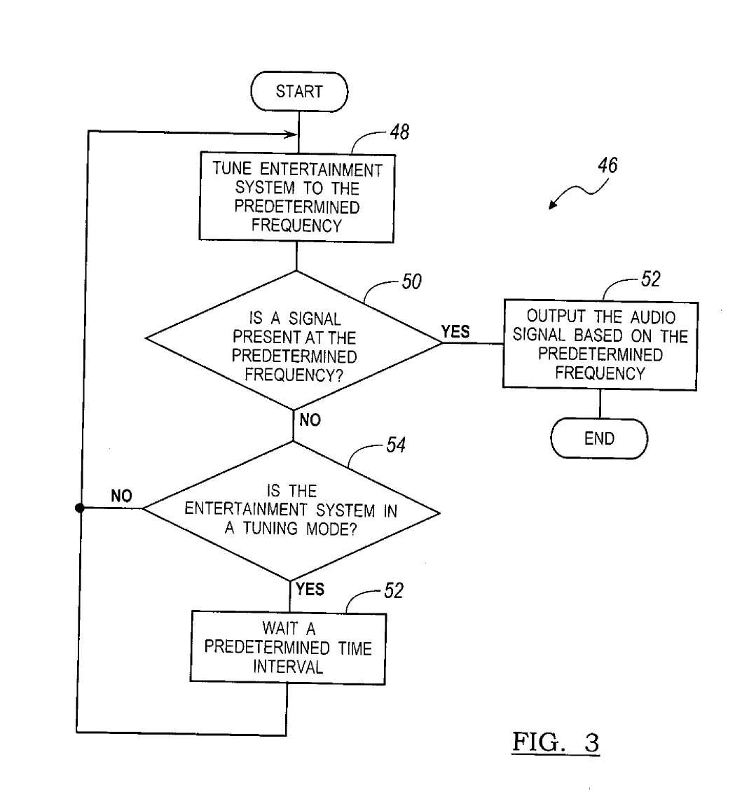

Referring to FIG. 3, a method 46 for automatically tuning the entertainment system 12 is shown. The method 46 begins with step 48, wherein the tuner 16 of the entertainment system 12 is automatically tuned to the predetermined audio frequency of the modulated audio device 30. The predetermined frequency is a preset frequency that is set by the occupant via the user interface 18. The predetermined frequency will be that of the frequency utilized by the modulator 34 in transmitting the radio waves 40. By automatically having the entertainment system 12 search for sufficiently high radio waves transmitted at the predetermined frequency, the entertainment system 12 can determine if a user is using a modulated audio device 30. This avoids the time consuming steps and inconvenience of requiring the user to manually tune the tuner 16 via the user interface 18.

Thereafter, in step 50, a determination is made if a signal is present at the predetermined audio frequency. This can be determined through a variety of different ways that are well known in the art. One way involves measuring the signal strength of the radio frequency within the channel. If the signal strength is above a certain threshold, a determination is made that a signal is present. Another way involves determining the amount of noise present at the predetermined frequency. If the amount of noise is low, a determination is made that a signal is present. Finally, another way involves looking at the frequency before demodulation and counting the number of zero crossings within a certain range and time window. Of course, it should be understood that these three methods may be used individually or in concert with one another to increase the robustness of the system. If a signal is present at the predetermined frequency, an audio signal based on the predetermined frequency will be outputted to the audio output device 24 as shown in step 52. Otherwise, the method continues to step 54.

In step 54 a determination is made if the entertainment system 12 is in a tuning mode or a non-tuning mode. The tuning mode is when the audio output device 24 is outputting an audio signal based on one or more frequencies received via the tuner 16. For example, if the tuner 16 is currently receiving an FM or AM radio station, and is outputting the FM or AM radio station to the audio output device 24, the processor 14 will determine that the entertainment system 12 is in a tuning mode. The processor 14 will determine that the entertainment system 12 is in a non-tuning mode when the audio output device 24 is not outputting an audio signal based on the one or more radio frequencies received by the tuner 16. For example, this would be a situation in which the entertainment system is receiving signals from a secondary source, such as a compact disc player.

If the entertainment system 12 is in a tuning mode, the method 46 waits a predetermined time interval as shown in step 56. By only monitoring the predetermined radio frequency at predetermined intervals, the user will be unaware that the entertainment system 12 has tuned out of the user selected frequency because the amount of time it takes to determine if the predetermined frequency is sufficiently high is fairly short. Returning to step 54, if a determination is made that the entertainment system is in a non-tuning mode, the method returns to step 50. In the non-tuning mode, because the user is utilizing another a secondary source, such as a compact disc player, the user's enjoyment of audio originating from the secondary source will not be affected if the tuner remains turned to the predetermined frequency.

As a person skilled in the art will readily appreciate, the above description is meant as an illustration of implementation of the principles of this invention. This description is not intended to limit the scope or application of this invention and that the invention is susceptible to modification, variation and change, without departing from the spirit of the invention as defined in the following claims.

1. An entertainment system, the system comprising:
a tuner in communication with an antenna;
a processor in communication with the tuner, the processor being configured to instruct the tuner to tune into one or more radio frequencies;
an audio output device in communication with the processor, the audio output device configured to output an audio signal based on the one or more radio frequencies received by the tuner;
a memory unit in communication with the processor, the memory unit containing a set of processor executable instructions to configure the processor to tune the tuner to a predetermined frequency, to determine a signal is present at the predetermined frequency and to output an audio signal based on the predetermined frequency to the audio output device when the signal at the predetermined frequency is present.

2. The system of claim 1, further comprising:
a portable audio device outputting an audio device signal;
a modulator in communication with the portable audio device, the modulator configured to output a radio wave transmitting at the predetermined frequency based on the audio device signal.

3. The system of claim 1, further comprising a user interface in communication with the processor, the user interface being configured to receive a frequency identifier corresponding to the predetermined frequency.

4. The system of claim 1, wherein the processor is configured to determine if the entertainment system is in a tuning mode or a non-tuning mode, the entertainment system being in a tuning mode when the audio output device is outputting an audio signal based on the one or, more radio frequencies received by the tuner, the entrainment device being in a non-tuning mode when the audio output device is not outputting an audio signal based on the one or more radio frequencies received by the tuner.

5. The system of claim 4, wherein the processor is further configured to check the predetermined frequency at periodic intervals when in the tuning mode.

6. The system of claim 4, wherein the processor is further configured to tune and remain tuned to the predetermined frequency when in the non-tuning mode.

7. The system of claim 1, wherein the entertainment system is installed in an automobile.

8. A method for automatically tuning an entertainment system to interface with a modulated audio device, the method comprising the steps of:
tuning a tuner of the entertainment system to a predetermined audio frequency of the modulated audio device;
determining if a signal is present at the predetermined audio frequency; and
outputting an audio signal based on the predetermined frequency to an audio output device if the signal is present at the predetermined radio frequency.

9. The method of claim 8, further comprising the step of determining if the entertainment system is in a tuning mode or a non-tuning mode, the entertainment system being in a tuning mode when the audio output device is outputting an audio signal based on the one or more radio frequencies received by the tuner, the entrainment device being in a non-tuning mode when the audio output device is not outputting an audio signal based on the one or more radio frequencies received by the tuner.

10. The method of claim 9, further comprising the step of tuning to the predetermined frequency at periodic intervals when the entertainment system is in the tuning mode.

11. The method of claim 9, further comprising the step of tuning and remain tuned to the predetermined frequency when the entertainment system is in the non-tuning mode.

12. The method of claim 8, further comprising the step of selecting the predetermined frequency of the modulated audio device.

13. The method of claim 8, wherein the modulated audio device includes a portable audio device operatively coupled to a modulator.
